(19) United States
(12) Patent Application Publication
(10) Pub. No.: US 2020/0254810 A1
(43) Pub. Date: Aug. 13, 2020

(54) CONTINUOUS DRAWING METHOD

(71) Applicants: Kim Johnson, Denver, CO (US); Jonathan Applegate, Denver, CO (US)

(72) Inventors: Kim Johnson, Denver, CO (US); Jonathan Applegate, Denver, CO (US)

(21) Appl. No.: 16/270,324

(22) Filed: Feb. 7, 2019

(51) Int. Cl. B44D 2/00; B44F 3/00

(52) U.S. Cl. CPC B44D 2/00; B44F 3/00

(57) ABSTRACT

A method of continuously drawing a series of alpha-numerical characters, an image, or a design or scene on a surface with a drawing instrument in which no line intersects any other line and no portion of characters is retraced. Images and designs can also be incorporated with continuous alpha-numerical characters. Also disclosed is a method of drawing an image on a surface that simulates a three-dimensional object or scene. Products can be created using any of the above-described techniques. Such products can include, but not be limited to greeting cards, postcards, apparel, coffee mugs, toys, games, puzzles, and the like. The surface on which the image is drawn can be made of material suitable for three-dimensional reliefs, so that visually impaired individuals can appreciate the work.

### FIELD OF THE INVENTION

This invention relates to drawing systems and, more particularly, to a continuous drawing method in which no line crosses another and no line is retraced.

### BACKGROUND OF THE INVENTION

Drawing is the art or technique of producing images on a surface, usually paper, by means of marks, usually of ink, graphite, chalk, charcoal, or crayon. Several categories of drawing include figure drawing, cartooning, doodling, lettering, and freehand. Drawing is primarily a linear rendition of objects in the visible world, and is the end product of a successive effort applied directly to the surface. As one of the oldest forms of human expression within the visual arts, drawing is considered an autonomous work of art, independent of the other arts.

As an artistic endeavor, drawing is almost as old as mankind, developing along with the other arts in antiquity and the Middle Ages. In 17th-century Italy, drawing became an independent art form. Artistic practice and experimentation became established in the academies, especially in Bologna. Landscape drawing was developed by the brothers Agostino and Annibale Carracci and articulated further by Domenichino and Salvator Rosa.

Well-known artists have been associated with the art and technique of drawing. For example, Pablo Picasso knew how to make use of its manifold technical possibilities. He has been called the greatest draftsman of the 20th century and one of the greatest in the history of drawing. Before him, Leonardo da Vinci developed definite principles of graphic representation, including stylization, patterns, and diagrams.

Typically, artists and illustrators draw a portion of the work continuously and then start another portion by re-applying their drawing instrument to the surface to continue with one or more additional portions, stopping and starting the drawing process a plurality of times in the process of creating a given work. The present invention, however, addresses a new technique of continuously drawing, eliminating the conventional stopping and starting process. In this way, a single line is drawn continuously to complete a work. The result is a new form of art expression that combines the elements of minimalism, cubism, surrealism, and impressionism.

### DESCRIPTION OF RELATED ART

U.S. Pat. No. 7,701,457 issued to Bae for PEN-BASED 3D DRAWING SYSTEM WITH GEOMETRIC-CONSTRAINT BASED 3D CROSS CURVE DRAWING on Apr. 20, 2010, describes a pen-based system that allows users, such as artists, graphic designers and illustrators, to create accurate curve models by sketching. A tool set implemented in software that runs on a computer system combines paper sketch metaphors and a minimalist gesture set. This tool set provides an environment where the artists can focus on the creative task at hand rather than the details of operating software. A pen-based drawing method and system allows users to create and edit three dimensional (“3D”) objects by sketching.

U.S. Pat. No. 5,844,566 issued to Lecland, et al. for METHOD AND APPARATUS FOR CONTROLLING SHADOW GEOMETRY ON COMPUTER DISPLAYS on Dec. 1, 1998, describes a method and apparatus for controlling shadow geometry on a computer display in an interactive computer display system. The method and apparatus comprises: maintaining primary element information defining a primary element; generating shadow geometry information defining a shadow geometry, the shadow geometry information having a predetermined mathematical relationship with the primary element, the shadow geometry information being generated in response to user manipulation of the primary element; integrating the shadow geometry with the primary element to form a single graphical unit (called a “par”); and selectively displaying the secondary element concurrently with the primary element.

U.S. Pat. No. 7,701,457 issued to Schell, et al. for SYSTEM AND METHOD FOR THREE-DIMENSIONAL MODELING on Sep. 30, 2003, describes a three-dimensional design and modeling environment that allows users to draw the outlines, or perimeters, of objects in a two-dimensional manner, similar to pencil and paper. The two-dimensional, planar faces created by a user can then be pushed and pulled by editing tools within the environment to model three-dimensional volumes and geometries.

U.S. Pat. No. 5,490,241 issued to Mallgren, et al. for INTERACTIVE COMPUTER GRAPHICS SYSTEM FOR MAKING PRECISE DRAWINGS on Feb. 6, 1996, describes a computer-aided illustration system and method that emulates the set of tools that are typically available to the traditional technical illustrator and also provides the user with the ability to create illustrations in various two-dimensional projections, including paraline and perspective projections. The techniques described include: (1) providing moving polar grids which restrict a drawing to a user-specified geometry; (2) combining arbitrary user-specified directional constraints with several types of gravity, in a manner which enables a user to create new objects in alignment with previously drawn objects; (3) interrelating constraint systems and geometries (as delineated in the polar grids) with gravity, thereby providing the user with an effortless way to create objects with complex geometric interdependencies; and (4) adapting tools from linear geometry to work in non-linear projection planes (paraline and perspective).

U.S. Pat. No. 5,444,836 issued to Hollingsworth, et al. for APPARATUS AND METHOD FOR IMPROVED PLACEMENT OF OBJECTS IN COMPUTER AIDED DRAFTING on Aug. 22, 1995, describes apparatus and methods for creating and applying flexible, user defined rules for placement of graphical objects in a computer aided drafting (CAD) application. The rules for precise placement and over plotting of graphical objects may be defined by a user with significant flexibility. The user defined rules are applied by the placement subsystem of the present invention to automate the proper placement of graphical objects according to the specific rules of the particular user. CAD systems are enhanced by their integration with an automated placement subsystem.

U.S. Pat. No. 5,299,307 issued to Young for CONTROLS FOR DRAWING IMAGES ON COMPUTER DISPLAYS on Mar. 29, 1994, describes a computer system that provides a method and an apparatus for generating and manipulating graphic objects on a computer display screen. The computer aided design and drawing system includes a graphic guide used for associating edges and points of one graphic image with one or more other images. The graphic guide operates in relation to the position of a cursor on the computer display screen. After a first image has been drawn on the screen, the graphic guide automatically is initiated to assist the user in positioning and sizing a second and subsequent images that are drawn on the display screen. The computer system also includes a wall tool used for efficiently generating wall objects displayed on the display screen, generated and manipulated by specifying the width of the wall, displaying joints between walls, capping the ends of walls, and measuring the interior, exterior or center dimension of a wall. Also included is a clean-up tool used for manipulating and modifying the intersection, the joining, and the extension of graphic images displayed on the display screen. The clean-up tool can be used to automatically remove interior line segments of objects, to remove desired portions of objects, or to automatically extend and join two objects.

### SUMMARY OF THE INVENTION

In accordance with the present invention, there is provided a method of continuously drawing a series of alpha-numerical characters, an image, or a design or scene on a surface with a drawing instrument in which no line intersects any other line, no portion of characters is retraced, and the drawing instrument can begin at any portion of the series of characters or image or design and end at any portion thereof. Characters are connected to one another with a line. In the case of images and designs, more details are drawn with illuminated areas or foreground objects of the image than are drawn with shadowed or background areas of the image. Images and designs can also be incorporated with continuous alpha-numerical characters.

Also disclosed is a method of drawing an image on a surface that simulates a three-dimensional object or scene. Colored lines are and shapes are used so that the image is perceived as a three-dimensional image when an observer views the image through ChromaDepth® material. The image that simulates a three-dimensional object or scene can be drawn using a conventional multi-line technique, in which lines can intersect other lines and portions of the image can be retraced. Alternatively, the continuous drawing technique, in which no line intersects any other line and no portion of the image is retraced, can be used with the three-dimensional image or design.

Products can be created using any of the above-described techniques. Such products can include, but not be limited to greeting cards, postcards, apparel, coffee mugs, toys, games, puzzles, and the like.

The surface on which the image is drawn can be made of material suitable for three-dimensional reliefs, so that visually impaired individuals can appreciate the work.

It is therefore one object of the invention to provide a method of continuously drawing a series of alpha-numerical characters with a drawing instrument in which no line intersects any other line and no portion of characters is retraced.

It is another object of the present invention to provide a method of continuously drawing in which a drawing instrument can begin at any portion of the series of characters and end at any portion of the series of characters.

It is yet another object of the present invention to provide a method of continuously drawing characters having cutouts or islands therewithin.

It is a further object of the present invention to provide a method of continuously drawing an image or design (e.g., a building, a landscape, or a portrait) in which no line intersects any other line and no portion of characters is retraced.

It is another object of the present invention to provide a method of drawing a design that simulates a three-dimensional object or scene when the observer uses ChromaDepth® eyeglasses.

It is yet another object of the present invention to provide a method of printing in which colors are used to change depth in a three-dimensional design.

It is a further object of the present invention to provide a method of creating a product, such as a postcard, toy, game, t-shirt, playing card, or puzzle, for example, that utilizes the continuous drawing method.

These and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a front view of an image of alpha-numeric characters drawn in accordance with the method of the invention;

FIG. 2 is a front view of a graphical design of roses in a flower vase;

FIG. 3 is another front view of a graphical design, this being of Union Station in Denver, Colo.;

FIG. 4 is a front and inside view of a greeting card having a graphical design drawn in accordance with the method of the invention;

FIG. 5 is a graphical design of the El Capitan rock formation in Yosemite National Park which can be viewed as a three-dimensional scene; and

FIG. 6 is a perspective view of a beverage holder on which an image or scene is printed in three-dimensional relief to aid visually disabled persons to perceive the image.

Like reference numerals refer to like parts throughout the several views of the drawings.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

A method is provided of a method of continuously drawing a series of alpha-numerical characters, an image, or a design or scene on a surface with a drawing instrument in which no line intersects any other line and no portion of characters is retraced. Images and designs can also be incorporated with continuous alpha-numerical characters. Also disclosed is a method of drawing an image on a surface that simulates a three-dimensional object or scene. Products can be created using any of the above-described techniques. Such products can include, but not be limited to greeting cards, postcards, apparel, coffee mugs, toys, games, puzzles, and the like. The surface on which the image is drawn can be made of material suitable for three-dimensional reliefs, so that visually impaired individuals can appreciate the work.

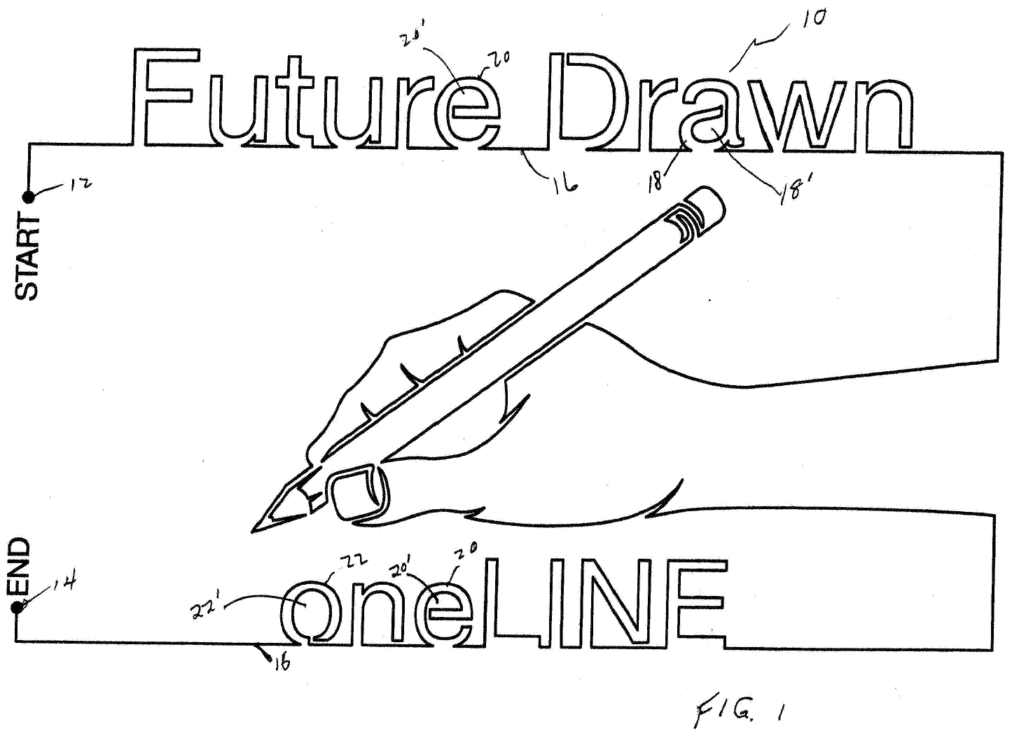

Referring now to FIG. 1, there is shown a front view of an image of outlined alpha-numeric characters, generally at reference numeral 10, drawn in accordance with the method of the invention. Outlined characters are required with the inventive technique, as the drawing implement (not shown) does not retrace lines. The image is drawn, starting at the point labeled START 12 and ends at the point labeled END 14. When the characters or design images end and start at the same point, those characters or designs can be drawn from any location thereon.

A single reference line 16 appears below the upper line of text and also below the lower line of text. This technique allows all of the characters to be connected to one another via reference line 16. All characters are connected to reference line 16.

Certain characters, such as the lower case letters a 18, e 20, and o 22, contain islands or isolated portions, 18′, 20′, and 22′, respectively. To draw these islands without raising the drawing implement from the drawing surface, the outer line of the island becomes the inner portion thereof, as shown. This technique is also used for other characters (e.g., the lower case letters g, k, and p) and design features having islands.

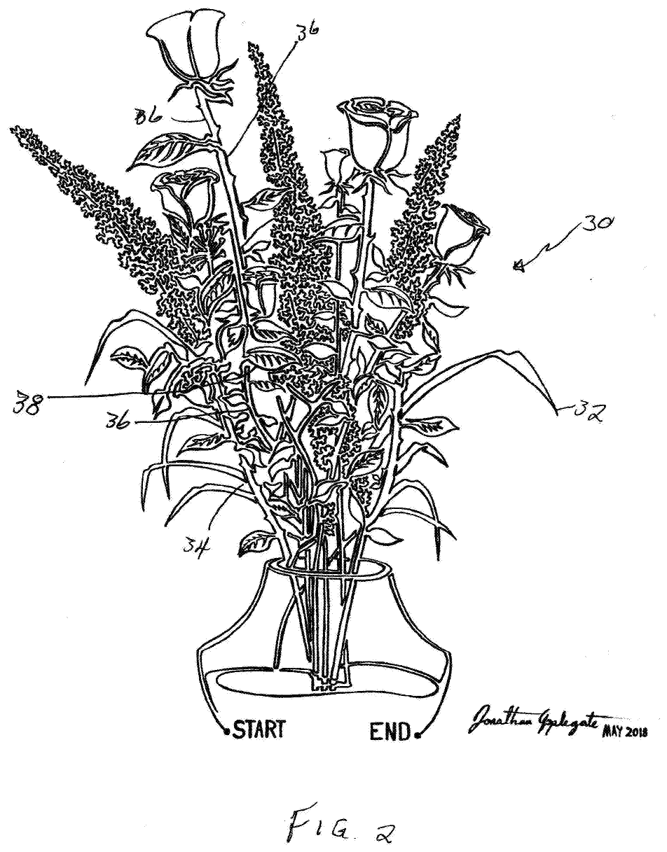

Referring now to FIG. 2 a front view of a graphical design of roses in a flower vase 30 are shown. No outline characters appear in this figure. In order for the drawing implement to reverse direction at certain positions, a converging or truncating feature is used, such as shown at reference numerals 32 and 34. Truncating feature 32, 34 can be a point, a rectilinear shape, or a curve, depending on the design. The inventive technique also allows for superimposition of elements and shapes in designs by removing background sections therefrom. Thus, a stem 36 extends downwardly in FIG. 2, superimposed with leaves 38.

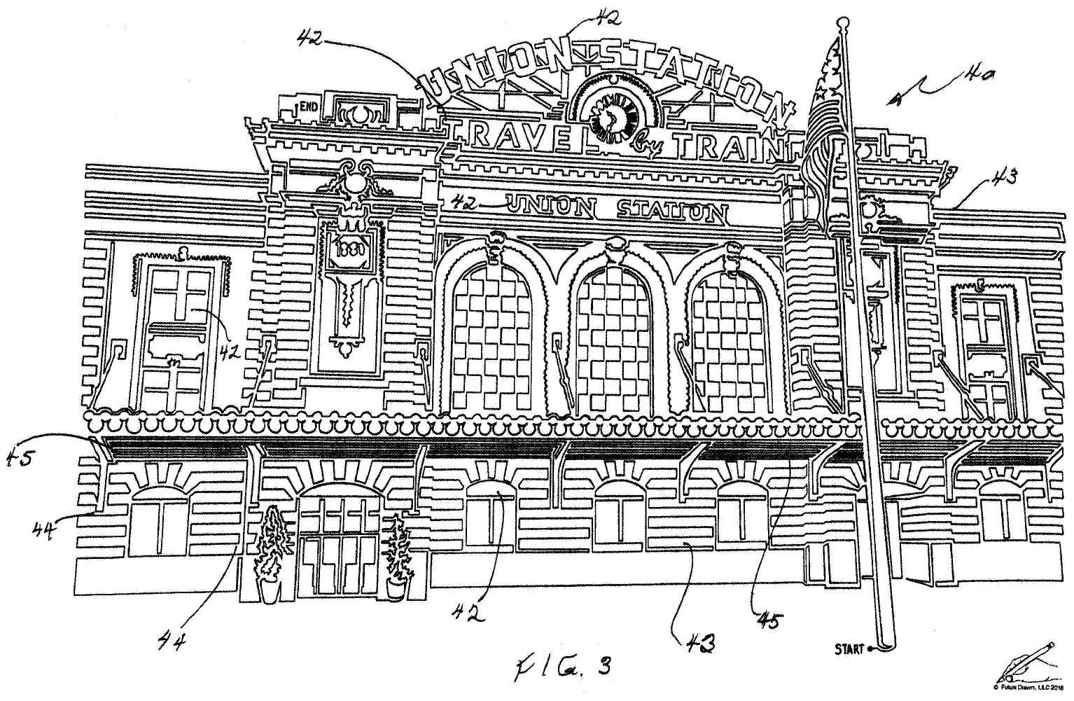

Referring now to FIG. 3, a front view of a graphical design of Union Station in Denver, Colo. 40 is shown. Outline characters 42 appear in this figure. Both islands 42 and truncation features 44 are shown in this FIG. 3. Illuminated features 43 of building 40 have fewer detail than features in the shadow 45 of building 40.

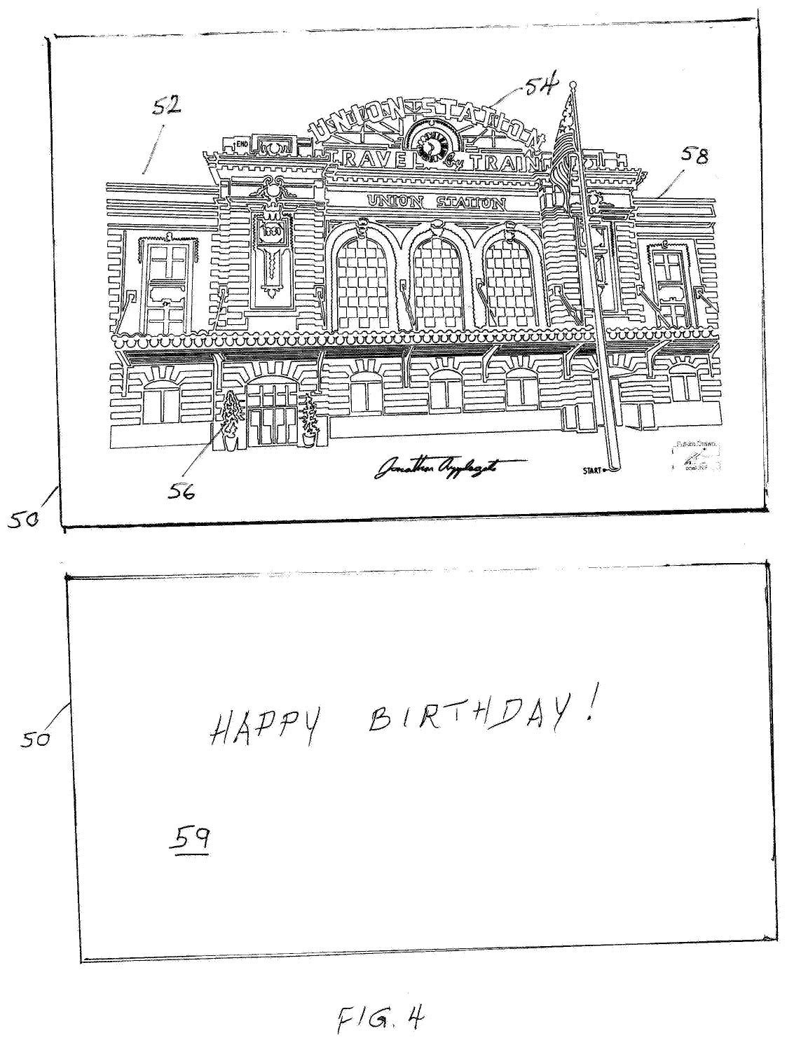

Referring now to FIG. 4, a front and inside view of a greeting card 50 having a graphical design of a building and garden 52 are shown. Greeting card 50 has outline characters 54 printed at the uppermost position thereof. Features at the foreground plants and flowers 56 of design 52 have more detail than features at the background building 58 of design 52. The inside 59 of greeting card 50 can be blank or have words, images, or combinations thereof printed thereon.

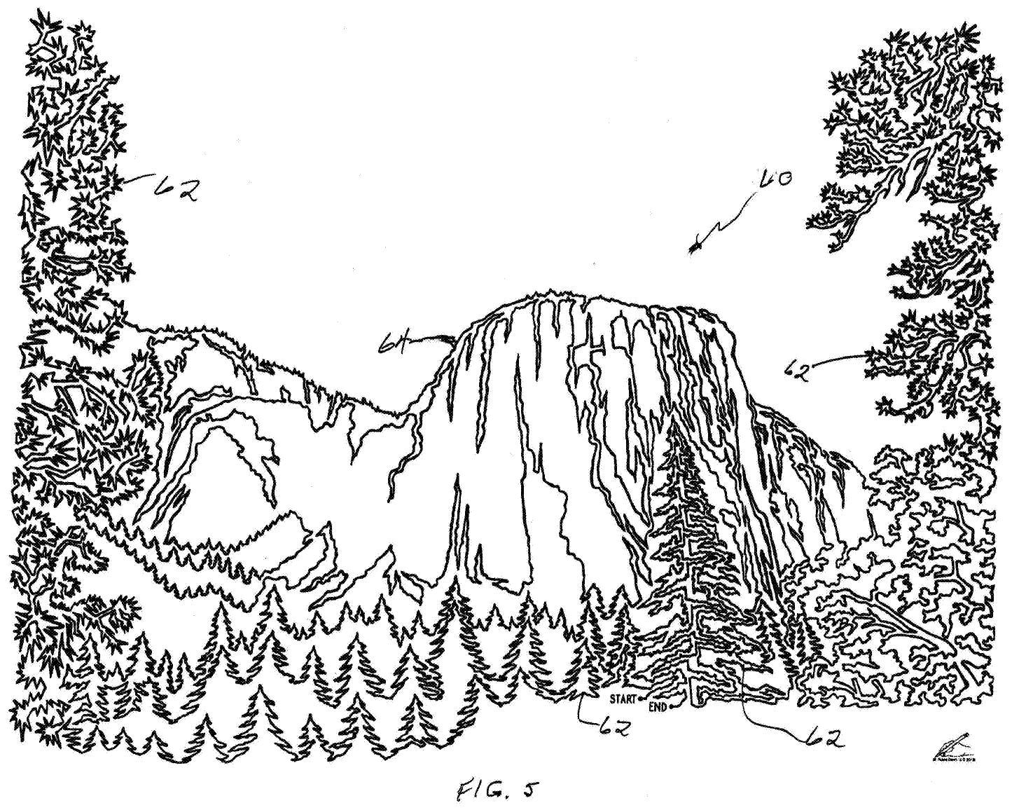

Referring now to FIG. 5, a graphical design of El Capitan Mountain 60 in Yosemite National Park, which can be viewed as a three-dimensional scene, is shown. FIG. 5 can be colored with the foreground vegetation 62 in red hues and the background rock formation 64 in blue hues. When observed with special glasses, the effect is three dimensional, the foreground features 62 appearing to be closer to the observer than the background features 64.

ChromaDepth® eyeglasses are manufactured by Paper Optics, Inc. of Bartlett, Tenn. The glasses do not require two images. Information is encoded from a single image through the use of binary optics and color. The 3D ChromaDepth® glasses create 3D images from normal 2D images by pulling forward the color red to the foreground and sorting the remaining colors according to their position in the rainbow.

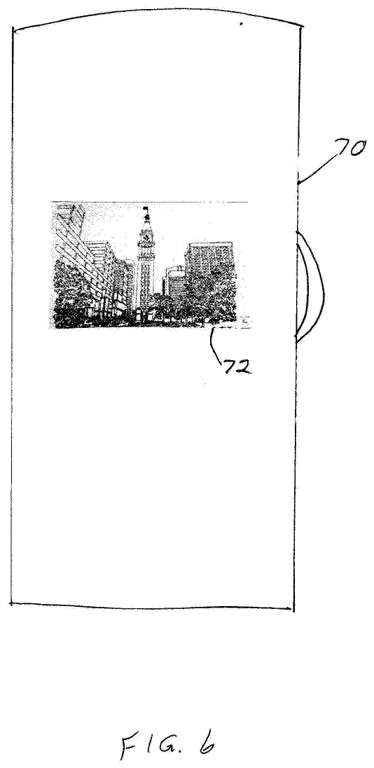

Certain types of accessible art can be produced with the aforementioned continuous drawing technique. Referring now to FIG. 6, there is shown a perspective view of a beverage holder 70 on which an image or scene 72 is printed in three-dimensional relief to aid visually disabled persons to perceive the image. This is an example of a three-dimensional tactile medium, such as vinyl, glass, paper, metal, etc. used as the surface of a drawing. That is, any of the images described hereinabove can appear on material suitable for three-dimensional reliefs, including but not limited to postcards, greeting cards, toys, games, t-shirts, playing cards, or puzzles.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a great number of variations of the devices, device components, and method steps set forth in the present description. As will be obvious to one of skill in the art, methods and devices useful for the present methods can include a great number of optional composition and processing elements and steps. The techniques described hereinabove can easily be applied to computer software, for example, to automate them, as is well known to those skilled in the computer arts.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A method of continuously drawing a series of alpha-numerical characters on a surface with a drawing instrument in which no line intersects any other line, no portion of characters is retraced, and the drawing instrument can begin at any portion of the series of characters and end at any portion of the series of characters, the steps comprising:
a) drawing an outline of each character on a surface; and
b) connecting each character to the next character in a series of characters with a line extending from the closest point of one character to the closest point of another character.

2. The method of continuously drawing a series of alpha-numerical characters in accordance with claim 1, the steps further comprising:
c) drawing a reference line proximate the series of characters; and
d) connecting each character to the reference line.

3. The method of continuously drawing a series of alpha-numerical characters in accordance with claim 2, wherein the reference line is drawn at a location chosen from a set of locations consisting of: below, adjacent, proximate, and above the series of characters.

4. The method of continuously drawing a series of alpha-numerical characters in accordance with claim 1, the steps further comprising:
c) creating an island in at least one character comprising an outer line of the island that converts to an inner line of the island.

5. A method of continuously drawing an image, design, or scene in which no line intersects any other line and no portion of the image is retraced, the steps comprising:
a) drawing an outline of a first portion of an image; and
b) drawing an outline of a second portion of an image and connecting the second portion to the first portion of the image.

6. The method of continuously drawing an image, design, or scene in accordance with claim 5, wherein foreground and background objects are placed in the image and sections of background objects are removed so foreground objects are superimposed thereover.

7. The method of continuously drawing an image, design, or scene in accordance with claim 6, wherein details are provided for illuminated areas of the image and fewer details are provided for shadowed areas of the image.

8. The method of continuously drawing an image, design, or scene in accordance with claim 6, wherein details are provided for foreground objects in the image and fewer details are provided for background objects in the image.

9. The method of continuously drawing an image, design, or scene in accordance with claim 5, wherein portions of the image are terminated by truncation proximate an interrupting feature using a technique chosen from a set of geometries consisting of: rectilinear, curved, and pointed terminations.

10. The method of continuously drawing an image, design, or scene in accordance with claim 5, further comprising a series of alpha-numerical characters.

11. A method of drawing an image, a design, or a scene on a surface that simulates a three-dimensional object or scene in which no line intersects any other line and no portion of the image is retraced, the steps comprising:
a) drawing a complete image with foreground and background objects;
b) drawing foreground objects with colored lines having first predetermined wavelengths; and
c) drawing background objects with colored lines having second predetermined wavelengths shorter than the first predetermined wavelengths;
whereby the image is perceived as a three-dimensional image when an observer views the image through ChromaDepth® material.

12. The method of drawing an image, a design, or a scene that simulates a three-dimensional object or scene in accordance with claim 11, the steps further comprising:
d) drawing a black line between objects having different colors to eliminate color interference.

13. The method of drawing an image that simulates a three-dimensional object or scene in accordance with claim 11, the steps further comprising:
d) shading predetermined objects with different colors.

14. The method of drawing an image that simulates a three-dimensional object or scene in accordance with claim 13, wherein details are provided for illuminated areas of the image and fewer details are provided for shadowed areas of the image.

15. The method of drawing an image that simulates a three-dimensional object or scene in accordance with claim 13, wherein details are provided for foreground objects in the image and fewer details are provided for background objects in the image.

16. The method drawing an image that simulates a three-dimensional object or scene in accordance with claim 11, further comprising a series of alpha-numerical characters.

17. The method drawing an image that simulates a three-dimensional object or scene in accordance with claim 11, wherein a material used to draw the image comprises paint.

18. A printed product produced by a method of continuously drawing an image on a surface in which no line intersects any other line and no portion of the image is retraced, the steps comprising:
a) drawing a complete image with foreground and background objects on a surface;
b) drawing foreground objects in the image; and
c) drawing background objects in the image.

19. The printed product in accordance with claim 18, wherein the printed product is chosen from a set of products consisting of: greeting cards, postcards, books, bookmarks, toys, games, apparel, playing cards, and puzzles.

20. The printed product in accordance with claim 18, wherein the surface comprises material suitable for three-dimensional reliefs to aid visually impaired individuals to appreciate the product.
